(19) United States
(12) Patent Application Publication
(10) Pub. No.: US 2014/0194095 A1
(43) Pub. Date: Jul. 10, 2014

(54) SYSTEM AND METHOD FOR MESSAGE IDENTIFICATION AND NOTIFICATION

(71) Applicant: WaveMarket, Inc., Emeryville, CA (US)

(72) Inventors: Russell Wynne, San Francisco, CA (US); Naren Thiagarajan, San Francisco, CA (US); Tyler Duni, Oakland, CA (US); David Hora, San Francisco, CA (US)

(21) Appl. No.: 14/147,802

(22) Filed: Jan. 6, 2014

Related U.S. Application Data
(60) Provisional application No. 61/749,353, filed on Jan. 6, 2013.

(51) Int. Cl. H04W 4/12; H04M 1/725

(52) U.S. Cl. CPC H04W 4/12; H04M 1/72577
USPC 455/411; 455/466; 455/456.6; 455/26.1

(57) ABSTRACT

A message identification and notification method is provided which includes detecting an incoming message from a first user to a mobile communication device corresponding to a second user. A particular indication in the incoming message is detected, and a notification is provided to the second user using the mobile communication device responsive to detecting the particular indication in the incoming message. One or more of an application and a functional component of the mobile communication device is disabled responsive to detecting the particular indication. A communication from the second user to the first user is detected, the communication initiated after the incoming message from the first user, and the one or more of the application and the functional component of the mobile communication device is enabled responsive to detecting the communication from the second user to the first user. A mobile communication device is also provided.

### CROSS REFERENCE TO RELATED APPLICATION(S)

This application claims the benefit of U.S. provisional application No. 61/749,353, filed Jan. 6, 2013, which is incorporated by reference as if fully set forth.

### BACKGROUND

Text messaging is a common means for communication among mobile device users. Short Message Service (SMS) protocol is commonly used for sending short text messages. Multimedia Messaging Service (MMS) protocol is commonly used for sending text messages with embedded multimedia content. Mobile device users may receive and send several text messages in a day.

There are many reasons why an urgent text message requiring a response may get overlooked or ignored by the receiver. For example, the text message may go unnoticed among several other messages received concurrently, the receiver may read the message and forget to respond, or for example in the case of children receiving messages from their parents, they may simply decide to ignore the text message. Unfortunately, there are times when failing to respond to a text message or other electronic communication has negative consequences for either the sending or receiving party.

### SUMMARY

A message identification and notification method is provided. The method includes detecting an incoming message from a first user to a mobile communication device corresponding to a second user. A particular indication in the incoming message is detected, and a notification is provided to the second user using the mobile communication device responsive to detecting the particular indication in the incoming message. At least one of an application and a functional component of the mobile communication device is disabled responsive to detecting the particular indication. A communication from the second user to the first user is detected, the communication initiated after the incoming message from the first user, and the at least one of the application and the functional component of the mobile communication device is enabled responsive to detecting the communication from the second user to the first user.

Another message identification and notification method is further provided. The method includes detecting an incoming voice message from a first user to a mobile communication device corresponding to a second user, and detecting at least one of a particular sound and a particular word in the in the incoming voice message. A notification is provided to the second user using the mobile communication device responsive to detecting the at least one of the particular sound and the particular word in the incoming voice message. The at least one of the application and the functional component of the mobile communication device is disabled responsive to detecting the at least one of the particular sound and the particular word. The method further includes determining that the incoming voice message is heard by the second user, and enabling the at least one of the application and the functional component of the mobile communication device responsive to determining that the incoming voice message is heard by the second user.

Further provided is mobile communication device including at least one non-transitory computer readable storage medium having encoded thereon instructions that, when executed by one or more processors, cause the mobile communication device to perform a process. The process includes detecting an incoming message from a first user to a mobile communication device corresponding to a second user, detecting a particular indication in the incoming message, providing a notification to the second user using the mobile communication device responsive to detecting the particular indication in the incoming message, and disabling at least one of an application and a functional component of the mobile communication device responsive to detecting the particular indication. The process further includes detecting a communication from the second user to the first user, the communication initiated after the incoming message from the first user, and enabling the at least one of the application and the functional component of the mobile communication device responsive to detecting the communication from the second user to the first user.

Further provided is a non-transitory computer readable storage medium having encoded thereon instructions that, when executed by one or more processors of a computing system, cause the computing system to perform a process. The process includes detecting an incoming message from a first user to a mobile communication device corresponding to a second user, detecting a particular indication in the incoming message, providing a notification to the second user using the mobile communication device responsive to detecting the particular indication in the incoming message, and disabling at least one of an application and a functional component of the mobile communication device responsive to detecting the particular indication. The process further includes detecting a communication from the second user to the first user, the communication initiated after the incoming message from the first user, and enabling the at least one of the application and the functional component of the mobile communication device responsive to detecting the communication from the second user to the first user.

### BRIEF DESCRIPTION OF THE DRAWING(S)

A more detailed understanding may be had from the following description, given by way of example with the accompanying drawings. The Figures in the drawings and the detailed description are examples. The Figures and the detailed description are not to be considered limiting and other examples are possible. Like reference numerals in the Figures indicate like elements wherein:

FIGS. 1 and 2 are screen shots of an example mobile device display.

FIG. 3 is a mobile device showing another example mobile device display.

FIG. 4 is a schematic diagram showing a system in which a device is configured for message identification and notification.

FIG. 5 is a diagram showing a process for message identification and notification.

### DETAILED DESCRIPTION OF ILLUSTRATIVE EMBODIMENT(S)

The following describes an application implemented by a mobile communication device (“mobile device”) designed to help users avoid negative consequences of failing to respond to an electronic message, for example a text message. A mobile device can include for example a smartphone or other processor-enabled computing device.

The application helps a receiving party to identify urgent messages and to encourage the receiving user to read and respond to urgent messages. An urgent message can be any message deemed by a sender to require a response or other action by the receiving party.

As described herein, a message sender is enabled to use a standard messaging interface to send urgent messages, for example standard text message interface (e.g., Short Message Service “SMS” message interface). A message sender includes a token, pattern, or signal in their standard text message sent from a text message application. Text message applications are often included by default on a mobile device as part of the device's operating system. An application on the receiver's mobile device intercepts this incoming text message and recognizes the token, pattern, or signal. For example, if the token, pattern, or signal is “??” the sender may send the following text message to a mobile device of the sender's child “Billy”:

“Billy, I need to know when you plan on coming home today??”

The application installed on Billy's mobile device (the recipient), intercepts the text message and flags it as urgent.

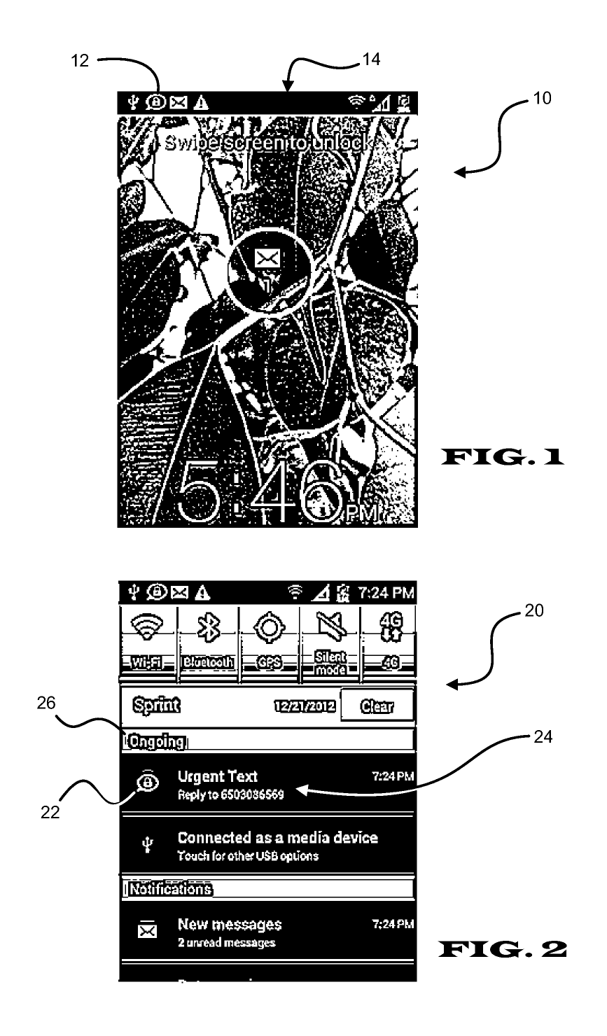

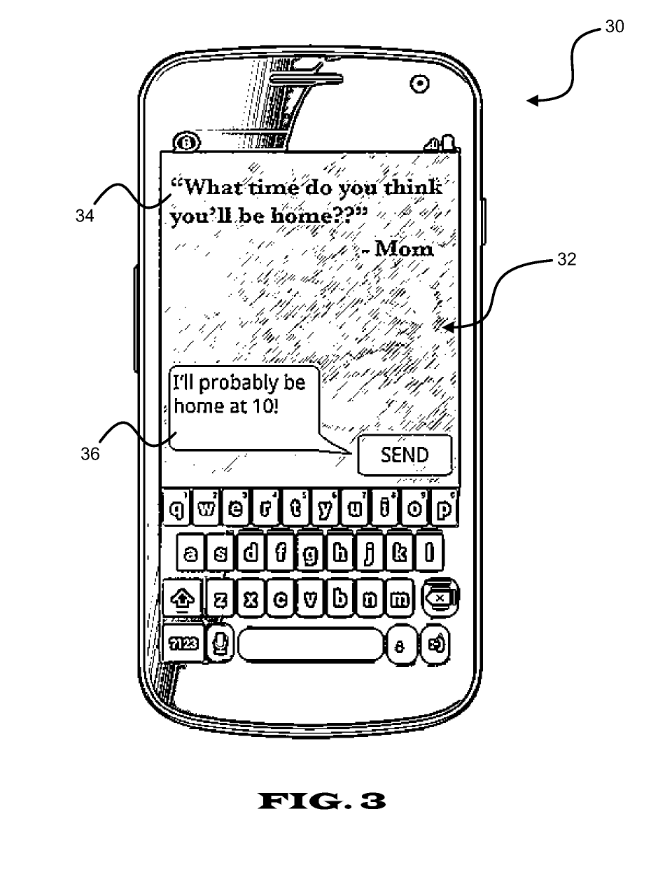

When a message is flagged as urgent, the application can take any number of steps to ensure that the recipient sees the message, and can further require a response. In one embodiment, the application can take one or more of the following steps upon receiving a particular standard text message with the designated “urgent” token, pattern, or signal:
1) An icon map 12 can be displayed in a notification bar 14 of a display 10 of the receiving mobile device indicating to the user that they have received an urgent text message, for example as illustrated in FIG. 1 showing a screen shot of the receiving mobile device display 10.
2) If the mobile device is unlocked, the application can initiate a countdown after which the application lock screen will be displayed as described below. The countdown corresponds to an allotted amount of time for the receiver to respond to the urgent text message.
3) An icon 22 and message 24 can be displayed in a pull down menu 26 notifying the receiver that they have received an urgent text message, for example as illustrated in FIG. 2 showing another screen shot of a receiving mobile device display 20. If the phone number or other identifying information of the sender is saved in the mobile device's address book or other datastore, the application can pull the contact name and display it in the pull down menu.
4) If the receiver responds to the urgent text message within the allotted amount of time, the notifications are cleared and the user can resume normal use of the mobile device.
5) If after the allotted amount of time the urgent message still has not been responded to, the application can display an interface that effectively locks the mobile device. A mobile device 30 showing an example lock screen 32 is shown in FIG. 3. This lock screen 32 may for example only show the received urgent message 34 and an input field 36 where a response can be typed. The lock screen 32 can prevent access to other features of the receiver's mobile device 30, including preventing access to other applications, other text messages, other voice calls, or any suitable functional components of the mobile device. For example, incoming calls and text messages may still be received by the mobile device, but saved into an SMS inbox or directed to a voicemail datastore automatically without notifying the recipient. Additionally, the lock screen 32 may allow the user to make emergency (e.g., 911) calls.
6) The user may respond to the urgent message by completing an outgoing call to the sender. This may be enabled for example by a button on the lock screen.
7) Once a response is sent, the device is unlocked, allowing the receiving user full access to the mobile device features (i.e. functional components and applications) again. The sent and received messages appear normally in the user's text logs, and normal mobile device operations can be resumed.

If several urgent messages are received simultaneously, steps 1-6 will be followed per message and each message will require a response unless they are from the same number, in which case only the last message will require a response.

In other embodiments, one or more of the following steps can also be followed:
1) The application can enable automatic reply to the urgent messages with a response that can include one or more of the following:
   a. Confirmation that message has been received and marked as urgent.
   b. An indication that the recipient's mobile device will remain locked until a response is sent.
   c. The battery level of the recipient's mobile device (e.g. 35% battery remaining, approximately 4 hours)
   d. The current location of the recipient's mobile device (the location may only be sent to recipients who were pre-approved.)
2) The application can enable sending out additional notifications when the recipient's mobile device battery is low if the urgent message has not been responded to. For example, the additional “low battery notification” may include any or all of the following:
   a. The battery level of the recipient's device (e.g. 5% battery remaining, approximately 30 minutes).
   b. Confirmation that device remains locked until the recipient responds.
   c. The current location of the recipient's mobile device (the location may only be sent to recipients who were pre-approved).
3) The application can cause the recipient's mobile device to emit a sound and/or vibration when an urgent message is received and then again, periodically until the recipient responds to the message.
4) The application can enable blocking of incoming calls when the recipient's mobile device is “locked”, but allow the recipient to receive incoming calls from the sender of the urgent text message.
5) The application can also intercept voicemails flagged as “urgent” and lock the mobile device until the receiver has heard the voicemail. A sender can for example dial a particular number while leaving a voicemail which sound the application can detect, or alternatively speak particular words that the application can detect as corresponding to an urgent message.

The application can be configured in different manners. For example, the application can be configured by either the potential recipient user who operates the mobile device to receive urgent messages, or alternatively by a supervisory user such as a parent who is otherwise in control of such mobile device. The supervisory user is authorized to enable the application on the mobile device for example by being the owner of a telecommunication carrier account which enables operation of the mobile device. In another embodiment, the application can be preinstalled on the mobile device at purchase and accept customizations from the person setting up the application. For example, the person setting up the application can elect to only accept “urgent” messages from a select group of senders.

Regardless of which embodiment of the application is implemented, the application at its most basic functionality can help to prevent urgent messages from being overlooked by first notifying the receiver of the message's importance, and then preventing the user from ignoring the message by initiating a lock screen.

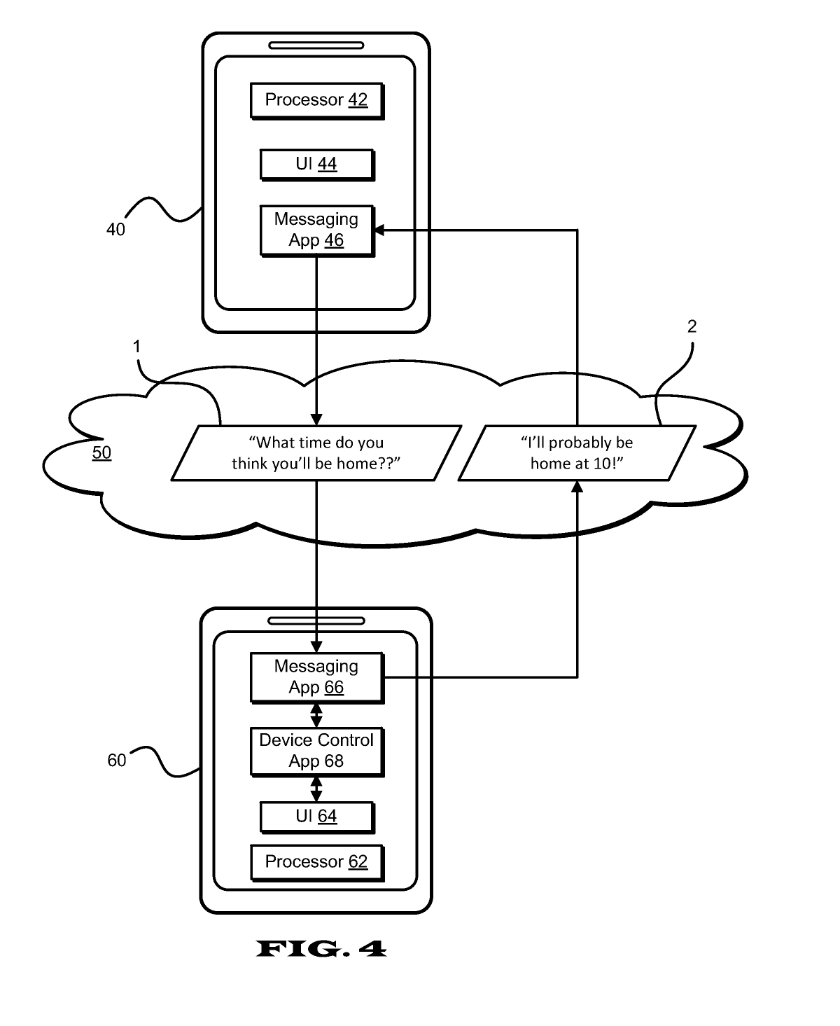

Exemplary device systems as described above are illustrated diagrammatically in FIG. 4. A first mobile device 40 corresponding to a supervisory user such as a parent includes a processor 42 which enables a user interface 44 and a messaging application 46 (e.g., an SMS messaging application). A second mobile device 60, corresponding to a supervised user such as a child, includes a processor 62 which enables a user interface 64, a messaging application 66, and a device control application 68. It is readily apparent to one skilled in the art that mobile communication devices can communicate through a network 50 such as a wireless telecommunication network, as shown in FIG. 4.

The device control application 68 determines if messages received by the messaging application 66 include a particular indication. If so, the device control application 68 disables one or more applications and functional components on the second mobile device 60. In FIG. 1, an exemplary message 1 from the first mobile device 40 to the second mobile device 60 via the respective messaging applications 46, 66 includes the particular indication “??”, which for example triggers the device control application 68 to disable the user interface 64 until the supervised user (e.g., child) sends a response message to the supervisory user (e.g., parent), which response message is shown as exemplary message 2.

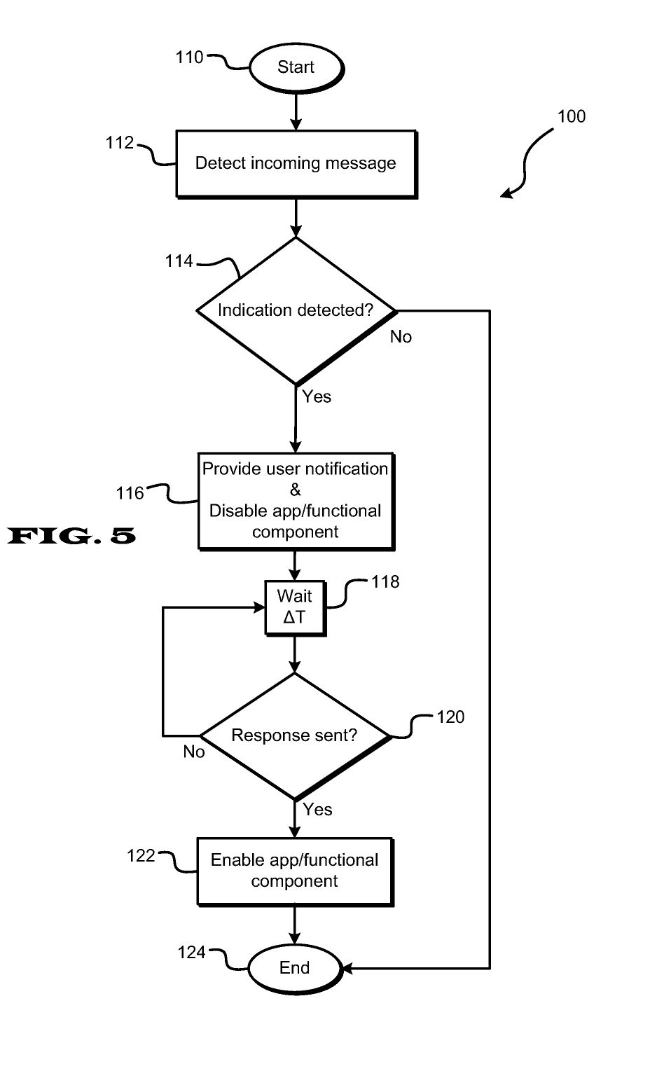

Referring to FIG. 5, a process 100 as described above is illustrated diagrammatically. As indicated above, the process can be implemented for example by an application executed on a mobile communication device via a processor. The process 100 starts at step 110. The process 100 includes detecting an incoming message to a mobile device (step 112) corresponding to a particular user. It is determined in step 114 if a particular indication is included in the incoming message. If the particular indication is not detected, the process ends at step 124. If the particular indication is detected, a notification is provided to the user of the mobile device, and one or more applications and/or functional components of the mobile device are disabled (step 116). After a waiting period (ΔT) 118 it is determined if the user sent a response via the mobile device to a sender of the incoming message (step 120). If it is determined that a response was not sent, the process returns to step 118. If it is determined in step 120 that a response was sent, the one or more applications and/or functional components of the mobile device are enabled (step 122), after which the process ends at step 124.

Although features and elements are described above in particular combinations, one of ordinary skill in the art will appreciate that each feature or element can be used alone or in any combination with the other features and elements. Methods described herein may be implemented in a computer program, software, or firmware incorporated in a computer-readable medium for execution by a computer or processor.

While embodiments have been described in detail above, these embodiments are non-limiting and should be considered as merely exemplary. Modifications and extensions may be developed, and all such modifications are deemed to be within the scope defined by the appended claims.

What is claimed is:

1. A message identification and notification method comprising:
detecting an incoming message from a first user to a mobile communication device corresponding to a second user;
detecting a particular indication in the incoming message;
providing a notification to the second user using the mobile communication device responsive to detecting the particular indication in the incoming message;
disabling at least one of an application and a functional component of the mobile communication device responsive to detecting the particular indication;
detecting a communication from the second user to the first user, the communication initiated after the incoming message from the first user; and
enabling the at least one of the application and the functional component of the mobile communication device responsive to detecting the communication from the second user to the first user.

2. The method of claim 1, wherein disabling the at least one of the application and the functional component comprises initiating a user interface lock preventing access to a plurality of functional components of the mobile communication device.

3. The method of claim 2, wherein initiating the user interface lock comprises providing a lock screen with a feature to enable the communication from the second user to the first user.

4. The method of claim 2, wherein enabling the at least one of the application and the functional component comprises disabling the user interface lock allowing access to the plurality of functional components of the mobile communication device.

5. The method of claim 1, wherein the particular indication comprises at least one of a token, a pattern, and a signal.

6. The method of claim 1, wherein the at least one of the token, the pattern, and the signal comprises at least one character entered by the first user in the incoming message.

7. The method of claim 1, wherein the providing the notification comprises indicating to the second user via the mobile communication device that an urgent message has been received.

8. The method of claim 1, further comprising:
initiating a countdown corresponding to an allotted amount of time for the second user to respond to the incoming message; and
disabling the at least one of the application and the functional component of the mobile communication device responsive to detecting the particular indication when the second user fails to respond to the incoming message within the allotted amount of time.

9. The method of claim 1, further comprising preventing access by the second user to at least one incoming communication during a period in which the at least one of the application and the functional component are disabled.

10. The method of claim 1, wherein the communication from the second user to the first user comprises a telephone call.

11. The method of claim 1, wherein the communication from the second user to the first user comprises a text message.

12. The method of claim 1, further comprising transmitting an automatic confirmation from the second mobile device to the first mobile device indicating that the incoming message was received by the second mobile device.

13. The method of claim 1, further comprising transmitting an automatic confirmation from the second mobile device to the first mobile device indicating a user interface lock has been initiated on the second mobile device.

14. The method of claim 1, further comprising responsive to detecting the incoming message:
determining a battery charge level of the second mobile device; and
transmitting an automatic confirmation from the second mobile device to the first mobile device indicating the determined battery charge level.

15. The method of claim 1, further comprising responsive to detecting the incoming message:
determining a location of the second mobile device; and
transmitting an automatic confirmation from the second mobile device to the first mobile device indicating the location of the second mobile device.

16. The method of claim 1, further comprising providing a periodic notification to the second user by the mobile device in the form of at least one of a sound and a vibration until the communication from the second user to the first user is detected.

17. The method of claim 1, wherein disabling the at least one of an application and a functional component of the mobile communication device comprises blocking a plurality of incoming calls and allowing incoming calls from the first user.

18. The method of claim 1, wherein:
the incoming message comprises a voice message; and
the particular indication comprises at least one of a particular sound and a particular word in the voice message.

19. A message identification and notification method comprising:
detecting an incoming voice message from a first user to a mobile communication device corresponding to a second user;
detecting at least one of a particular sound and a particular word in the in the incoming voice message;
providing a notification to the second user using the mobile communication device responsive to detecting the at least one of the particular sound and the particular word in the incoming voice message;
disabling at least one of an application and a functional component of the mobile communication device responsive to detecting the at least one of the particular sound and the particular word;
determining that the incoming voice message is heard by the second user; and
enabling the at least one of the application and the functional component of the mobile communication device responsive to determining that the incoming voice message is heard by the second user.

20. A mobile communication device comprising at least one non-transitory computer readable storage medium having encoded thereon instructions that, when executed by one or more processors, cause the mobile communication device to perform a process comprising:
detecting an incoming message from a first user to a mobile communication device corresponding to a second user;
detecting a particular indication in the incoming message;
providing a notification to the second user using the mobile communication device responsive to detecting the particular indication in the incoming message;
disabling at least one of an application and a functional component of the mobile communication device responsive to detecting the particular indication;
detecting a communication from the second user to the first user, the communication initiated after the incoming message from the first user; and
enabling the at least one of the application and the functional component of the mobile communication device responsive to detecting the communication from the second user to the first user.

21. A non-transitory computer readable storage medium having encoded thereon instructions that, when executed by one or more processors of a computing system, cause the computing system to perform a process including:
detecting an incoming message from a first user to a mobile communication device corresponding to a second user;
detecting a particular indication in the incoming message;
providing a notification to the second user using the mobile communication device responsive to detecting the particular indication in the incoming message;
disabling at least one of an application and a functional component of the mobile communication device responsive to detecting the particular indication;
detecting a communication from the second user to the first user, the communication initiated after the incoming message from the first user; and
enabling the at least one of the application and the functional component of the mobile communication device responsive to detecting the communication from the second user to the first user.
